(19) United States
(12) Patent Application Publication
(10) Pub. No.: US 2012/0274286 A1
(43) Pub. Date: Nov. 1, 2012

(54) METHOD AND DEVICE FOR IMPROVING THE PERFORMANCE OF ELECTRICALLY POWERED VEHICLES

(76) Inventors: Richard Aumayer, Diekholzen (DE); Jan Lichtermann, Oberriexingen (DE)

(21) Appl. No.: 13/505,529

(22) PCT Filed: Nov. 17, 2010
(86) PCT No.: PCT/EP10/67694

§ 371 Date: Jul. 17, 2012

(51) Int. Cl. H02J 7/00; B60L 1/02

(52) U.S. Cl. 320/150; 320/149; 219/202

(57) ABSTRACT

A method for improving the performance of a traction battery during a driving start phase of an electric vehicle. A driving start point in time at which the driving start phase begins is provided. A temperature of the traction battery is detected. This temperature is compared with a minimum operating temperature, and the traction battery is heated if the comparison reveals that the temperature of the traction battery is below the minimum operating temperature. The heating takes place with a temperature increase which provides a temperature of the traction battery at the driving start point in time, which is no lower than the minimum operating temperature.

### FIELD OF THE INVENTION

The present invention relates to the use of electrical energy storage mechanisms for driving and in particular mechanisms for modifying the operating parameters to improve the performance of traction batteries.

### BACKGROUND INFORMATION

Numerous models of electrically powered vehicles operated by a traction battery are available commercially. Traction batteries are used in hybrid vehicles and in electric vehicles to accelerate the vehicle. This requires a high output by the traction batteries, in particular within the context of traffic safety in traffic situations requiring strong acceleration. To provide a reliable high electric power output, there are numerous approaches which offer a high electric output due to the structure and composition of the traction battery.

Nevertheless, with numerous types of batteries, the output depends on a few operating parameters, whereby in a few operating parameter constellations, in particular at low temperatures, output is reduced and therefore reliability is also reduced. An object of the present invention is to provide a mechanism with the aid of which the availability of traction batteries may be increased.

### SUMMARY

According to the present invention, it has been recognized that an essential restriction on the power output occurs in particular when lithium ion batteries having solid electrolytes are operated at low temperatures. In particular, only reduced power levels are retrievable because of the reduced ion conductivity. It has been recognized that this may result in critical traffic situations, in particular in a driving start phase, for example, when a traction battery having a reduced performance has to strongly accelerate a vehicle to adapt the vehicle to the traffic situation.

In accordance with the present invention, a driving start point in time is provided which corresponds to a planned start of drive, and the traction battery is heated according to a temperature increase in which the temperature of the traction battery corresponds to or is higher than a minimum operating temperature at the driving start point in time but is not above the maximum allowed operating temperature of the battery. This may avoid the performance of the traction battery being reduced at the start of driving in cold weather until the traction battery has reached the minimum operating temperature during operation. Due to the timing of heating, which is adapted to the driving start point in time, it may be ensured that the performance of the traction battery is fully represented from the beginning.

Thus, according to the present invention, the traction battery is heated when a temperature below a minimum operating temperature, which depends on the type of battery, is detected. This preparatory heating also protects the traction battery and thus increases its lifetime. In addition to heating by electrical heating, which transfers heat to the traction battery, the traction battery is heated by charging the traction battery. Since charging increases not only the state of charge but also in particular essentially creates heat due to a low efficiency, in particular in the end-of-charge phase (i.e., charging phase of 80%-99% SOC), this results in a synergistic effect and no additional energy is needed for the temperature increase. Instead, a suitable shift of at least a part of the charging cycle is sufficient to achieve the desired temperature increase due to the heat which exists in charging. It is possible in particular to shift only one end-of-charge phase to the driving start point in time in such a way that it ends at the driving start point in time or a short period of time before that. “A short period of time” here means a time during which a traction battery which has already been heated cools off noticeably, in particular below the minimum operating temperature. For example, such a period of time is less than one hour, less than half an hour, less than a quarter hour or less than five minutes, depending on the design of the battery.

Such a two-part charging strategy makes it possible to transfer most of the energy to the battery in advance, for example, by making use of cost-effective off-peak electricity rates, without taking into account the desired increase in temperature. However, there is a remaining residual charge with a time shift, preferably the duration claimed by the residual charge first being detected, whereupon the time is calculated back from the driving start point in time in order to begin the residual charge with a time shift and to terminate it in such a way that the traction battery is fully charged, the charging, however, ending only the short period of time before the driving start point in time. The charging may therefore also take advantage of cost-effective off-peak electricity rates or take into account other charging operation specifications. The two-part charging operation may be provided according to a predefined state of charge, up to which the battery is charged in the first operation, so that the second part is responsible for the residual charge and is suitably shifted according to the present invention to a point in time before the driving start point in time. Instead of basing this on a state of charge, it is also possible to base it on an efficiency, which decreases with an increase in the state of charge. For example, the first phase of charging may relate to an efficiency which is greater than a predefined efficiency. The remaining second charging operation is then suitably shifted, a remaining charging time being calculated and appropriately shifted to a point in time before the driving start point in time. This period of time may be calculated from the efficiency because it depends on the state of charge, which in turn determines the residual charging time. The second charging operation is thus performed at a reduced efficiency and therefore ensures adequate heating and a high temperature increase. Depending on the initial temperature of the battery and the temperature conditions (e.g., a strong cold wind), additional heating by an electric heater may also be necessary to achieve the minimum temperature at which the battery is able to deliver its nominal power.

The present invention may be provided with the aid of an example method or with the aid of an example charge control device, which shifts at least a part of the charging operation to the driving start point in time in order to utilize the heat which is generated automatically while charging, to also increase the temperature, thereby ensuring that the minimum operating temperature will be reached by the planned driving start point in time.

Therefore, an example method for improving the performance of a traction battery during a driving start phase of an electric vehicle is provided according to the present invention. This method includes providing a driving start point in time at which a planned driving start phase begins. A driving start point in time of this type may be provided by an automatic timer or a clock timer, which reproduces the usual operating time intervals of the electric vehicle. In addition to repeating driving start points in time, individual events may also be stored in advance as the driving start point in time. The example method also provides for the temperature of the traction battery to be detected in order to determine whether heating results in an improvement in performance (for example, at low temperatures) or whether heating is unnecessary in the sense of improving performance. If it is found that the temperature is below the minimum operating temperature (as a result of a comparison step), then the traction battery is heated. The heating takes place according to a temperature increase, the end of which occurs before the driving start point in time by a predetermined period of time or ends at the driving start point in time, the temperature increase ending at a temperature which corresponds to the minimum operating temperature or is above it (by a safety margin, for example). Two alternatives, which may be combined for heating, include electrical heating by transfer of heat from an electric heater to the traction battery (for example, by a heater mounted directly on the battery) or in particular charging the traction battery. As previously described, heating by charging the traction battery allows the energy used for heating to not constitute an additional energy demand, but instead the desired heating may be achieved only through a suitable time shift of at least some of the charge.

The time shift of at least a part of the charging operation in order to provide an elevated temperature promptly at the driving start point in time is preferably based on detecting the initial state of charge. This relates in particular to a specific embodiment, in which heating is provided by charging the traction battery. The duration of the charging period is calculated on the basis of the state of charge detected according to the conventional method. A part of this charging period or the entire charging period is positioned in time, so that the entire charging period or a part of the charging period ends immediately with or at a predetermined time interval from the driving start point in time. Since the total duration of the charging period is known and thus the duration of a part of the charging period is also known, the start of the charging period, in particular, may be shifted in such a way that the charging period ends directly at the driving start point in time on the basis of the known duration, or in order to have a safety margin, it ends at a predetermined time interval before this time. This ensures that, first of all, the vehicle will be at (or higher than) the minimum operating temperature at the driving start point in time and at the same time the battery will be fully charged. If the battery is not fully charged because the actual driving start phase begins shortly before the driving start point in time, this ensures that the traction battery will be at least almost fully charged and the minimum operating temperature will have been reached already or at least almost completely due to the fact that the temperature increase is not entirely complete. In particular, in the case of a time division of the charging operation into a residual charge, which provides the desired temperature increase based on the driving start point in time, and at least one precharge, which is not shifted in time but instead preferably begins as soon as possible, it is possible to achieve the result that, firstly, the temperature at the starting time is correct, and secondly, the battery was at least partially charged even at a premature actual driving start point in time. Availability may therefore be ensured even when the actual driving start point in time is advanced significantly; on the other hand, the heating according to the present invention provides a temperature corresponding at least to the minimum operating temperature promptly at the planned driving start point in time.

One specific embodiment of such a two-part or multipart procedure is provided by delaying at least one last interval of the charging phase to synchronize the end of the last time interval with the driving start point in time. In this context, the word “synchronize” means that the end of the charging phase occurs as simultaneously as possible with the planned driving start point in time, the end of the charging phase also being shifted in a targeted manner by a predetermined period of time to take place before the planned driving start point in time. Since the duration of the last time interval is known (based on the state of charge and the charging time, which is calculated on that basis), it is possible to allow, in a targeted manner, the entire charging phase to begin when only the remaining charging time as of the planned driving start point in time remains. Although the heating, i.e., the heat generation, is a function of the efficiency and the charging current, a charging operation always generates heat, regardless of its time. According to the present invention, it is provided that at least the last time interval provides the heating step. Thus, the heating step is provided during the last time interval of the charging phase of the traction battery by charging the traction battery from a predefined state of charge to a full state of charge. Charging from the predefined state of charge to a full state of charge is linked to an efficiency, which is lower than an average efficiency, whereby heat is generated to a particularly great extent as a result of charging. The predefined state of charge in the case of a multipart form corresponds to the state from which the last charge cycle emanates and to which the preceding charging phase(s) have led in charging to this predefined state of charge. Predefining the state of charge and this type of two-stage or multistage charging ensures that the vehicle will already be available after a first charging phase, based on the partially charged battery, the second phase will generate a sufficient amount of heat to reach the minimum operating temperature and the efficiency in the last charging phase will cause sufficient production of heat.

The predefined state of charge may amount to 60%, 70%, 75%, 80%, 85%, 90%, 95% or a higher percentage of the total charging capacity available. For example, when a vehicle having a residual charge of 10% is charged according to the present invention, then the state of charge is first directly increased by charging to 80%, for example. Subsequently, the charging is interrupted until the second and last charging phases begin, the latter being concluded promptly at the driving start point in time. Since it is known that 20% is still to be charged, the remaining charging time may be ascertained easily from this and is subtracted from the planned driving start point in time to provide the start of the last charging phase. If necessary, ascertaining the duration may include adding an extra safety margin to ensure that the last charging phase is not concluded significantly after the driving start point in time or at least is in fact concluded at the driving start point in time, even if the data ascertained are incorrect. As already pointed out, the last charging phase which starts from a predefined state of charge is linked to a low efficiency, which is 98%, 97%, 95% or 93%, for example. The efficiency is obtained from the chemically converted quantity of energy in relation to the total charging energy supplied electrically. The remaining 2%, 3%, 5% or 7% corresponds to the heat generated, i.e., the conversion into heat of the electrical charging energy supplied. The efficiency may decrease with aging of the battery and may be calculated in particular by using conventional methods so that the efficiency may be taken into account when defining the predefined state of charge. The predefined state of charge relates either to a fixed number, as described above, or it is selected in such a way that its efficiency corresponds to a limiting value below which the lower efficiency described above prevails; this efficiency decreases with an increase in charge.

For correct timing, the method therefore includes calculating the remaining time required for charging the traction battery from the predefined state to the fully charged state. To do so, the quotient is calculated from the energy required for charging from the predefined state of charge to the full state of charge, and a charging power at which the traction battery is charged. This quotient may thus be calculated on the basis of the pure stored (and retrievable) electrical energy of the battery, which is added as a result of charging, based on the pure electrical power, which is converted without loss into electrically retrievable chemical energy. In another approach, the quotient is calculated based on the total energy, which must be supplied electrically to fully charge the battery and which includes in particular the heat loss with regard to the power supplied electrically to the battery, and which is converted, on the one hand, into a chemical reaction and therefore into a charge, and on the other hand, into heat. The time may thus be calculated on the basis of purely electrical considerations, or may take into account efficiency and thus the heat loss.

The purpose of another aspect according to the present invention is to minimize the residual charging process and for this purpose the temperature difference between the detected temperature and the minimum operating temperature is taken into account. According to this method, the charging time required to reach the operating temperature is calculated for this purpose. The required heating, which is defined by the temperature difference between the detected temperature and the minimum operating temperature, is linked to a charging time during which the required temperature increase is provided by the heating step. The calculation may be based on empirical data or on a lookup table, which links a temperature difference to a duration or a charging energy. Furthermore, the temperature difference may be calculated from the charging current, the efficiency of the charging and the effective thermal capacity which compares a temperature increase with the thermal energy increase. Instead of the charging current, the total amount of charging energy, which is transferred to the battery, may form the basis of the calculation replacing the charging current.

According to the present invention, the comparison step may include providing a temperature difference between the detected temperature and the minimum temperature in order to detect the required temperature increase. Furthermore, a heating time is provided, which increases with an increase in the temperature difference, usually based on the thermal capacity of the battery. The heating is performed for a heating period, whose duration corresponds to the heating time. The heating begins at a point in time, corresponding to the driving start point in time, which is moved forward by at least the heating time.

The method is suitable in particular for charging lithium ion batteries, which are provided for traction of electric vehicles or hybrid vehicles having an electric drive. The driving start point in time may be entered via a user interface, or driving start points in time of past driving periods may be detected, these times being averaged, for example, or combined in another form, a predetermined period of time having already been subtracted, if necessary, or the time to be subtracted depending on the scattering in the driving start points in time.

The present invention is also provided by a charge control device for implementing the method according to the present invention. The charge control device is provided for charging a traction battery and includes a temperature signal input, a comparator connected thereto, a time input, a charging signal output and a state-of-charge ascertaining device. Instead of a time input, the charge control device may also include an electronic clock, preferably a radio-controlled wireless clock. The comparator is equipped for comparing a temperature signal applied to the temperature signal input with a predefined minimum operating time. The state-of-charge ascertaining device also includes a state-of-charge ascertainer, which is equipped to detect the state of charge of the traction battery. The charge control device is equipped for estimating on the basis of the state of charge a charging time, which is necessary for full charging of the traction battery, starting from the detected state of charge, in order to reach the minimum operating temperature or an amount beyond that. The charge control device is equipped to subtract the charging time from a time applied to the time input, representing the driving start point in time, and to deliver a charging signal at the charging signal output for a charging period, which begins at the same time or before the driving start point in time minus the charging time. In embodiments in which the charge control device includes the electronic clock, it is also equipped to receive or provide the time, which indicates the point in time, in order to compare the instantaneous time with the desired driving start point in time according to a timer device and to notify the charge control device with the aid of a signal that the charging time is beginning.

According to another specific embodiment, the charge control device is equipped to deliver a preliminary charging signal to the charging signal output until reaching a predefined partial state of charge. The preliminary charging signal corresponds to a command to charge the battery in a first phase of a multiphase charging operation, in which at least the last charging step is shifted toward the desired driving start point in time according to the present invention. The preliminary charging signal makes it possible to provide a partial state of charge to thereby be able to use the cost-effective off-peak electricity rates, for example, or to increase availability by bringing the state of charge to a partial state of charge as soon as possible. The charge control device is also equipped to transmit a signal when the predefined partial state of charge has been reached. Furthermore, the state-of-charge ascertainer may be equipped to provide a preliminary charging time, which provides the duration of the preliminary charging signal. Therefore, either the state of charge is monitored regularly or repeatedly and a preliminary charge is provided until the detected state of charge corresponds to the partial state of charge, or a duration is provided which likewise ensures that the partial state of charge is reached after charging with this duration of the preliminary charging signal. In both cases, the charge control device is equipped to control this preliminary charging process by either repeatedly detecting the state of charge or detecting it continuously, so that the charge control is able to terminate a preliminary charging process appropriately or in that the charge control device itself provides the duration at which the preliminary charging process is executed. The charge control device is likewise equipped to provide a remaining charging time to control the residual charging process. The charge control device thus provides a remaining charging time, which corresponds to the difference between the predefined partial state of charge and the pre-charged state. To execute the last charging process, the charge control device is also equipped to subtract the remaining charging time from the time applied to the time input, which represents the driving start point in time, and to deliver the charging signal for the remaining charging period at the charging signal output, this charging period beginning with the remaining charging time or beginning before the driving start point in time minus the remaining charging period. In this regard, it is provided that the charge control device includes an electronic clock to provide the instantaneous time and accordingly to provide the charging signal for the last charging process, shifted toward the driving start point in time.

For this purpose, the charge control device includes either a clock, in particular the electronic clock, or an input for an instantaneous time signal. This time input thus provides the instantaneous time in electronic form, and the charge control device is equipped to begin the output of the charging signal at a point in time which corresponds to the driving start point in time minus the calculated duration. Alternatively, the charge control device is equipped to begin with the output of the charging signal at a point in time which corresponds to the driving start point in time minus the calculated duration and minus a predefined time reserve. The optional time reserve thus provided corresponds to a safety margin by which the last charging process is additionally moved forward.

The state-of-charge ascertaining device of the charge control device includes a model of the traction battery (for example, in the form of a formula or a proximity equation), a model of the traction battery which is trackable in time, for example, a model which simulates physical and chemical processes within the battery and which may be tracked according to the externally detectable measured variables. Externally detectable measured variables of this type include the temperature, the charging current and the terminal voltage, from which an internal resistance which is part of the model may be calculated, for example. The charge control device may also include a proximity device, a lookup table or an interpolator which may be linked to the lookup table. To provide the state-of-charge ascertaining device in an updatable form so that it is equipped to detect instantaneous measured values, the charge control device includes an input for physical measured variables of the traction battery, this input being connected to the state-of-charge ascertaining device. The physical measured variables, entering which the input is equipped for, include at least physical variables such as the temperature, the battery current or the battery terminal voltage.

The input may be provided as a digital interface, for example, which is equipped to record variables of this type in the form of digital or binary values. Based on the input for physical measured variables, the state-of-charge ascertaining device is equipped to provide or to at least estimate the instantaneous state of charge. This charge control device is equipped to subtract the charging time from a time applied to the time input representing the driving start point in time and to deliver a charging signal for a charging period at the charging signal output, this period beginning at or before the driving start point in time minus the charging time. The charging signal delivered by the charge control device may either be only a time duration signal, for example, in the form of a charge-start point in time and a duration or in the form of a charge-start point in time and a charge ending point in time. Alternatively, the charging signal itself may represent only an active/inactive state, the charging signal providing an active state when the traction battery is to be charged, and providing an inactive state when the battery is not to be charged. The state-of-charge ascertaining device or the charge control device itself is equipped to estimate a charging time, which is necessary for increasing the state of charge by a predetermined amount, or which is necessary for increasing the state of charge to a predetermined state of charge. In this estimate, which is provided by the ascertaining device, the capacity of the traction battery is taken into account, which is also provided by the state-of-charge ascertaining device, for example, on the basis of a model. On this basis, the associated duration is derived from the capacity and the current, the state-of-charge ascertaining device being equipped to divide an energy value by the power, the energy value corresponding to the residual capacity to be filled and the power corresponding to the charging current, so that the quotient of the energy and power yields the associated time for which the power must flow in order to provide the energy.

### BRIEF DESCRIPTION OF THE DRAWINGS

FIG. 1a shows the charging curve which occurs when charging conventionally, and in the method according to the present invention.

FIG. 1b shows an associated temperature diagram.

### DETAILED DESCRIPTION OF EXAMPLE EMBODIMENTS

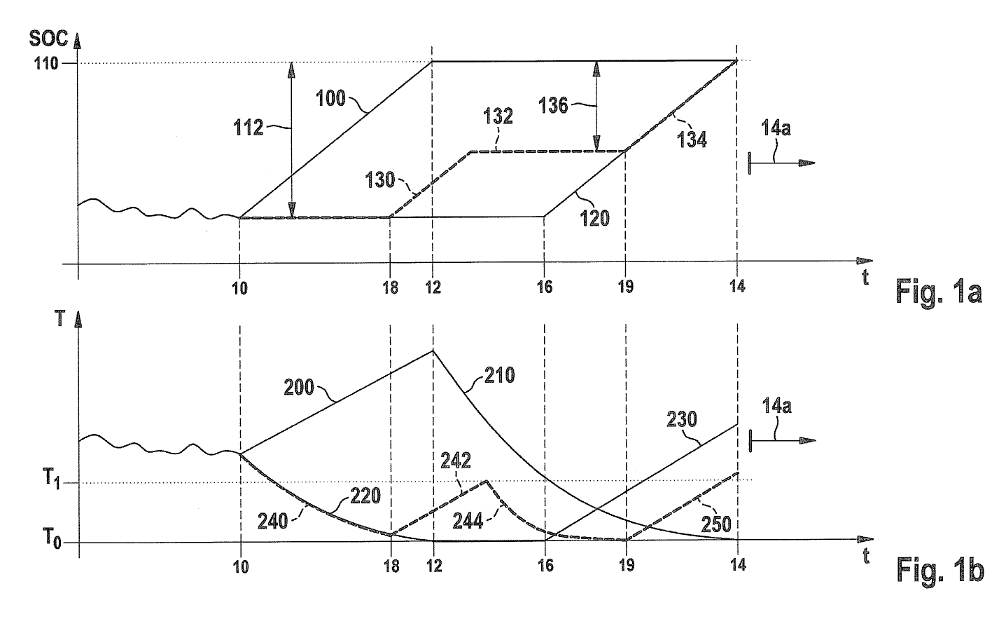

FIG. 1 shows state of charge SOC as a function of time t. Up to a point in time 10, the traction battery is used for driving, and immediately after the end of the driving operation, it is connected to a charging socket. Curve 100 shows the charging curve obtained with the known charging methods. Charging begins as soon as possible, i.e., at point in time 10, and ends on reaching the desired maximum state of charge 110, the maximum state of charge usually amounting to 100%, but possibly also assuming lower values. Charging is concluded at point in time 12, so that the state of charge remains at a desired maximum charging level 110 until driving start point in time 14. The driving start point in time marks the start of another phase which begins with a driving start phase.

It is apparent that in conventional charging operations, as represented by charging curve 100, there is first a temperature increase 200 beginning at point in time 10 and ending at point in time 12, i.e., when the battery is fully charged. Subsequently, in the absence of heating, the temperature drops according to temperature drop 210, so that at driving start point in time 14, the temperature corresponds to outside temperature T0, which is significantly lower than minimum operating temperature T1. At driving start point in time 14, the traction battery thus has an unacceptably low temperature in the charging method according to the related art, so that the power suffers at the start of driving start phase 14a.

In contrast, the example method according to the present invention provides for the required total charge quantity 112 to be detected and for the charging time to be calculated from that (for example, as the difference between points in time 12 and 10) and to shift the start of charging to a point in time 16, which is as close as possible to driving start point in time 14 but still leaves enough time to charge the battery by charging difference 112. The charging operation according to the present invention thus begins at point in time 16, which corresponds to the driving start point in time minus the calculated duration of the charging period. FIG. 1b shows the associated curve according to which the temperature first drops to outside temperature T0 according to curve 220, this temperature prevailing at start charging point in time 16. Since charging operation 120 is postponed and only begins at point in time 16, a temperature increase 230 results starting from point in time 16, providing at driving start point in time 14 a temperature which is significantly above minimum operating temperature T1. It is apparent that the method according to the present invention thus provides a high temperature according to temperature increase 230 already at the start of driving start phase 14a.

According to another specific embodiment, only some of the charge is shifted according to the present invention as close as possible to driving start point in time 14 and a first part enables the use of cost-effective off-peak electricity rates and a first charging step, which significantly increases the availability of the vehicle even before the driving start point in time.

In FIG. 1a, a charging operation of this type (illustrated by a dashed line) initially provides that no charging is performed until point in time 18, point in time 18 representing, for example, the start of a cost-effective off-peak electricity rate. According to the first charging phase the charging is increased as illustrated by increase 130. However, this increase does not result in a full charge up to maximum desired level 110. The charging process is then paused according to curve 132 and is then charged at point in time 19 which corresponds to the driving start point in time minus a warm-up time. The charging process taking place starting from point in time 19 corresponds to the second and last charging process which results in heating according to the present invention. Charging step 134 is thus provided according to the present invention in such a way that it ends at the driving start point in time and essentially provides the desired charging level 110 precisely at the driving start point in time. The associated temperature curve initially includes a first cooling 240 since no charging takes place before the start of the cost-effective off-peak electricity rate at point in time 18. Subsequently, an initial charging process 130 starts which is linked to a temperature increase 242. However, according to the present invention, it is not used for the temperature increase, so that in a subsequent cooling period 244 at point in time 19 the temperature of the traction battery again drops to outside temperature T0. However, the temperature increases starting from point in time 19 according to increase 250 to a temperature which is above the minimum operating temperature at the driving start point in time as a result of the second, i.e., the last, charging process 134 according to the present invention. The charge start of the last phase, i.e., charging phase 19, is derived from the temperature difference T0 and T1, if necessary adding an extra safety margin, to provide a temperature above minimum operating temperature T0 in a targeted manner. Furthermore, point in time 19, which marks the start of the last charging phase, may result from a residual charge amount 136 by which the state of charge is to be increased during the residual charging process. The state of charge which is provided by first charging process 130 may correspond to a predefined minimum state of charge which corresponds to a minimum range of the vehicle.

While temperature curve 210 which occurs in the charging method according to the related art provides a temperature that is too low at starting point in time 14, the charging processes according to the present invention allow a temperature increase 230 or 250, which enables an adequate temperature above the minimum operating temperature at driving start point in time 14. While the charging operation according to the specific embodiment described first provides an increase 120, whose goal is to make the full charging available exactly at the driving start point in time, the two-step method allows a first charging process 130 to be freely selected, which takes into account, for example, the more cost-effective off-peak electricity rates or minimum availabilities as well as a second charging operation 134, also referred to as the last charging operation, which is shifted as far as possible toward the driving start point in time according to the present invention, to provide the driving start phase with an adequate battery temperature.

The temperature curves in FIG. 1b are shown only as examples and are based on a simplified linear temperature increase 200, 242, 230, 250 as well as on a negative exponential temperature drop 210, 220, 240, 244, during which the battery temperature drops toward outside temperature T0. The charging currents may also be different, the same rise in the state of charge being assumed in FIG. 1a for each charging operation for simplicity reasons. In the same way, the temperature increases in FIG. 1b are shown having the same rising rates because FIG. 1a represents the same rise in the state of charge and thus the same charging current for all charging phases.

1-10. (canceled)

11. A method for improving performance of a traction battery during a driving start phase of an electric vehicle, comprising:
providing a driving start point in time at which the driving start phase begins;
detecting a temperature of the traction battery;
comparing the temperature with a minimum operating temperature; and
heating the traction battery to increase the temperature of the traction battery to a temperature which is no lower than the minimum operating temperature at the driving start point in time, if the comparison reveals that the temperature of the traction battery is below the minimum operating temperature.

12. The method as recited in claim 11, wherein the heating to increase the temperature is provided one of by charging the traction battery, by electrically heating the traction battery with the aid of an electrical heater, which is connected to the traction battery in a heat-transferring manner, or by charging the traction battery and by electrical heating.

13. The method as recited in claim 11, wherein the heating to increase the temperature is provided by charging the traction battery, and an initial state of charge of the traction battery is detected, on the basis of which a duration of a charging period is calculated, at least some of a charging period ending one of directly or at a predetermined time interval before the driving start point in time.

14. The method as recited in claim 11, wherein at least one last time interval of a charging phase is delayed in order to synchronize an end of a last time interval with the driving start point in time, and the heating step is provided during the last time interval of the charging phase of the traction battery by charging the traction battery from a predefined state of charge to a full state of charge, the charging from the predefined state of charge to a full state of charge being linked to a low efficiency, which is below an average efficiency.

15. The method as recited in claim 14, wherein the predefined state of charge amounts to one of 60% or more, 70% or more, 75% or more, 80% or more, 85% or more, 90% or more or 95% or more, or the low efficiency amounts to 98% or less, 97% or less, 95% or less or 93% or less, and the method further comprises:
calculating a remaining time needed to charge the traction battery from the predefined state of charge to the full state of charge by calculating a quotient from an energy required to charge from the predefined state of charge to a full state of charge and a charging power at which the traction battery is charged.

16. The method as recited in claim 11, wherein the comparing step includes:
providing a temperature difference between the detected temperature and the minimum operating temperature; and
providing a heating duration which increases with an increase in the temperature difference, the heating being performed for a heating period whose duration corresponds to the heating duration, which begins at a point in time which corresponds to the driving start point in time which is moved forward at least by the heating duration.

17. A charge control device to charge a traction battery, comprising:
a temperature signal input;
a comparator connected to the temperature signal input, the comparator being equipped to compare a temperature signal applied at the temperature signal input with a predefined minimum operating temperature;
a time input;
a charging signal output; and
a state-of-charge ascertaining device to detect a state of charge of the traction battery;
wherein the charge control device is equipped to estimate based on the state of charge, a charging time necessary for fully charging the traction battery, starting from the detected state of charge, the charge control device equipped to subtract the charging time from a time which is applied to the time input and represents the driving start point in time, and to deliver a charging signal for a charging period at the charging signal output, which starts at or before the driving start point in time minus the charging time.

18. The charge control device as recited in claim 17, wherein the charge control device is also equipped to deliver a preliminary charging signal to the charging signal output until a predefined partial state of charge is reached, and wherein one of the state-of-charge ascertainer is equipped to signal that a predefined partial state of charge has been reached, or the state-of-charge ascertainer being equipped to provide a preliminary charging time, which provides the duration of the preliminary charging signal, wherein the charge control device is equipped to provide a remaining charging time which corresponds to the difference between the predefined partial state of charge and the fully charged state, and wherein the charge control device is equipped to subtract the remaining charging time from the time applied at the time input, which represents the driving start point in time, and to deliver the charging signal for the remaining charging period at the charging signal output, the charging period beginning at or before the driving start point in time minus the remaining charging time.

19. The charge control device as recited in claim 17, further comprising:
one of a clock or an input for an instantaneous time signal, with the aid of which an instantaneous time is provided;
wherein the charge control device is equipped to start with the output of the charging signal at a time, which corresponds to one of the driving start point in time minus the calculated duration, or at a point in time which corresponds to the driving start point in time minus the calculated duration and minus a predefined time reserve.

20. The charge control device as recited in claim 17, wherein the state-of-charge ascertaining device includes one of a model of the traction battery, a chronologically tracking model of the traction battery, a proximity device, a lookup table, or an interpolator, and includes an input for physical measured variables of the traction battery connected to the state-of-charge ascertaining device, including at least one of a physical variables temperature, a battery current, or a battery terminal voltage, to provide the instantaneous state of charge, the state-of-charge ascertaining device also being equipped to estimate a charging time, which is necessary for increasing the state of charge one of by a predetermined amount, or to a predetermined state of charge.
